(19) United States
(12) Patent Application Publication
(10) Pub. No.: US 2010/0103393 A1
(43) Pub. Date: Apr. 29, 2010

(54) SCANNING EXPOSURE APPARATUS AND DEVICE MANUFACTURING METHOD

(75) Inventor: Junichi Motojima, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/606,046

(22) Filed: Oct. 26, 2009

(30) Foreign Application Priority Data
Oct. 27, 2008 (JP) 2008-275920

(51) Int. Cl. G03B 27/42; G03B 27/32

(52) U.S. Cl. 355/53; 355/77

(57) ABSTRACT

An apparatus comprises a device which measures a surface position of a substrate at a plurality of measurement points, and a controller configured to cause the device to measure the surface position under a condition that an arrangement direction in which the plurality of measurement points are arranged and a scanning direction of the substrate are not orthogonal to each other, wherein exposure on the substrate is controlled based on a measurement result obtained by the device.

### BACKGROUND OF THE INVENTION

1. Field of the Invention

The present invention relates to a scanning exposure apparatus and a method of manufacturing a device using the same.

2. Description of the Related Art

An exposure apparatus is employed to manufacture semiconductor devices having minute structures, such as a semiconductor memory and a logic circuit using photolithography. The exposure apparatus projects and transfers a pattern formed on an original (which can also be called a reticle or mask) onto a substrate (e.g., a wafer or a glass plate) by a projection optical system.

To improve the resolution and widen the exposure region, an exposure apparatus of the step & scan scheme has become the current mainstream. This scheme transfers the pattern of an original onto a substrate while scanning them. Such an exposure apparatus can be called a scanning exposure apparatus or scanner.

A scanner including a single substrate stage measures the surface shape of a substrate by a focus sensor, having measurement points 201 on its front side in the scanning direction, in parallel with exposure of a shot region 204 using slit-like exposure light 203, as shown in FIG. 2. With this operation, high-accuracy and real-time focus control is attained. This scheme adjusts the position of the substrate stage in the vertical direction (the optical-axis direction of a projection optical system) based on the measurement results obtained by the focus sensor. The scanning direction is parallel to the long side or short side of a rectangular shot region 301, as shown in FIG. 3. Errors of detection by the focus sensor can be eliminated by effects associated with repetition of shots and based on the macroscopic shape of the substrate surface (Japanese Patent Laid-Open No. 09-045608).

An exposure apparatus which transfers the pattern of an original onto a substrate using a plurality of substrate stages is commonly used to improve its processing capability (Japanese Patent Laid-Open No. 2000-323404). An exposure apparatus of this type measures the surface shape of a substrate in advance, and performs focus control during exposure based on the measured surface shape.

In measuring the surface shape of a substrate while scanning it, the scanning direction is generally parallel to the long side of a rectangular shot region defined by the design of an original (reticle design), as shown in FIG. 4. Also, measurement points 201 are generally arranged on the focus sensor in a direction parallel to the short side of the shot region. The distance between measurement target points in a direction parallel to the scanning direction can be determined depending on the response characteristic of the focus sensor. The distance between measurement target points in a direction perpendicular to the scanning direction can be determined depending on the distance at which measurement points are arranged on the focus sensor. In the example shown in FIG. 4, the distance between measurement target points in a direction parallel to the long side of the shot region is δx denoted by reference numeral 401. Also, the distance between measurement target points in a direction parallel to the short side of the shot region is δy denoted by reference numeral 402.

The distance between measurement target points in the scanning direction can be reduced by using a focus sensor with a high response characteristic and a high-speed processing system, or slowing down the scanning speed. On the other hand, the distance between measurement target points in a direction perpendicular to the scanning direction is equal to that at which measurement points are arranged on the focus sensor. For this reason, when the substrate to be measured has a surface shape 502 that changes in a cycle shorter than the arrangement distance of measurement points 501, as illustrated in FIG. 5, the focus sensor cannot detect the surface shape 502.

Furthermore, the width of a measurable region in which measurement points are arranged on the focus sensor is often different from that of a shot region, as shown in FIG. 6A. The measurement results obtained by a focus sensor having measurement points 602 positioned outside a shot region 600 are naturally invalid.

### SUMMARY OF THE INVENTION

One of the aspect of the present invention provides an apparatus comprises a device which measures a surface position of a substrate at a plurality of measurement points, and a controller configured to cause the device to measure the surface position under a condition that an arrangement direction in which the plurality of measurement points are arranged and a scanning direction of the substrate are not orthogonal to each other, wherein exposure on the substrate is controlled based on a measurement result obtained by the device.

Further features of the present invention will become apparent from the following description of exemplary embodiments with reference to the attached drawings.

### BRIEF DESCRIPTION OF THE DRAWINGS

FIG. 1 is a view showing the schematic arrangement of a scanning exposure apparatus according to an embodiment of the present invention;

FIG. 2 is a view for explaining a method of measuring the surface position of a substrate by the look-ahead scheme;

FIG. 3 is a view showing the relationship between a shot region and the scanning direction in a general measurement method;

FIG. 4 is a view illustrating the arrangement of measurement target points in a general measurement method;

FIG. 5 is a plot illustrating the relationship between the arrangement distance of measurement points and the surface shape of a substrate;

FIGS. 6A to 6C are views exemplifying a measurement method according to an embodiment of the present invention;

FIG. 7 is a view illustrating the arrangement of measurement points;

FIG. 8 is a flowchart schematically showing the sequence of substrate processing in the first embodiment of the present invention;

FIG. 9 is a view exemplifying a measurement method according to an embodiment of the present invention;

FIG. 10 is a view illustrating the relationship between a shot region and measurement points in a general measurement method;

FIG. 11 is a flowchart schematically showing the sequence of substrate processing in the second embodiment of the present invention; and

FIG. 12 is a flowchart schematically showing the sequence of substrate processing in the third embodiment of the present invention.

### DESCRIPTION OF THE EMBODIMENTS

Embodiments of the present invention will be described below with reference to the accompanying drawings.

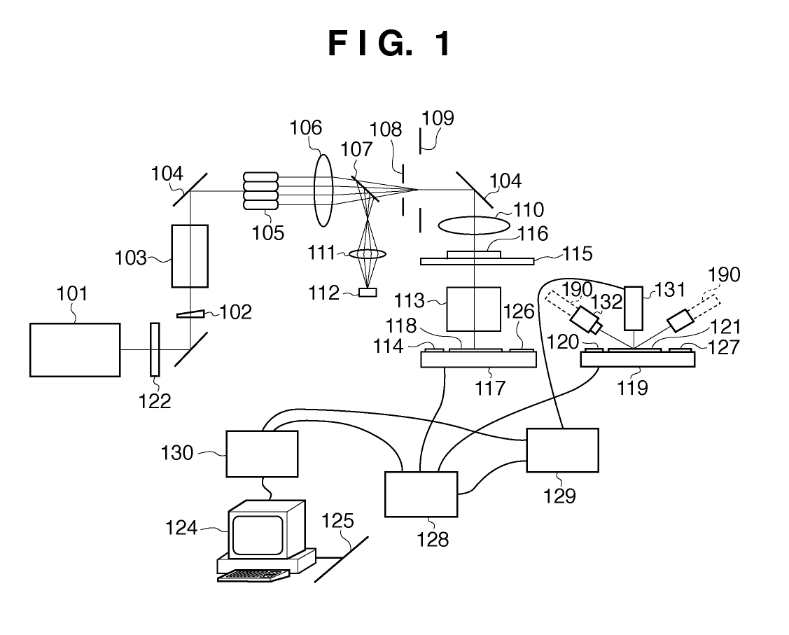

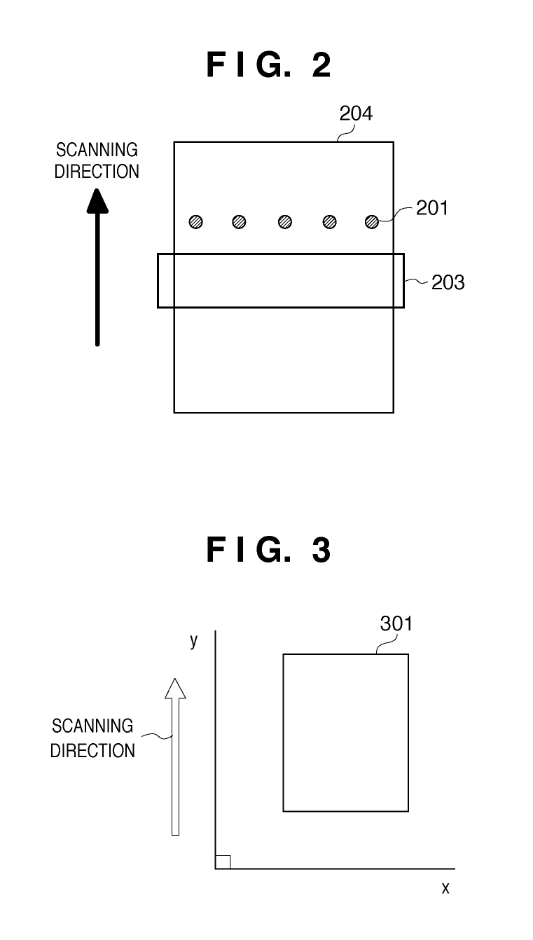

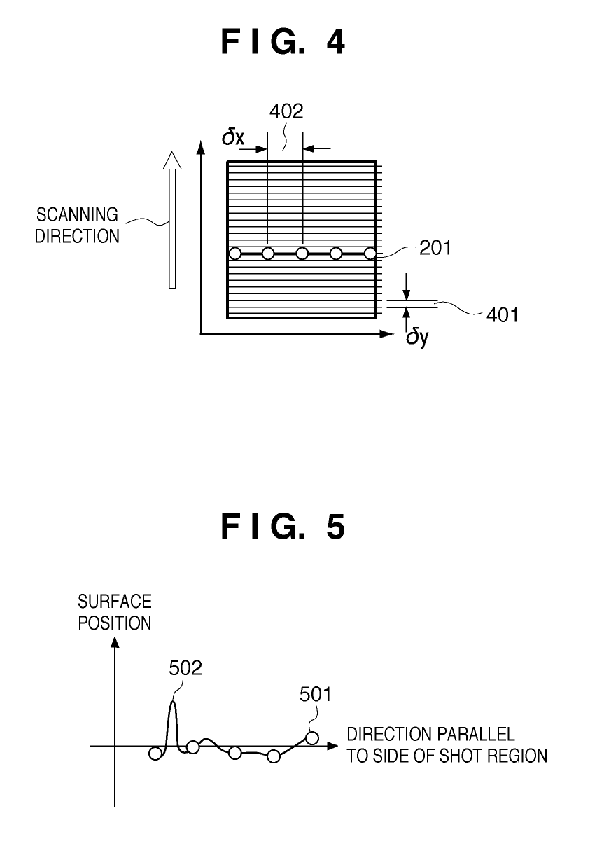

FIG. 1 is a view showing the schematic arrangement of a scanning exposure apparatus according to a first embodiment of the present invention. A light source 101 is, for example, an excimer laser or an i-line lamp. Light emitted by the light source 101 reaches an optical member 122. The optical member 122 is used to attenuate the light intensity. The optical member 122 includes, for example, optical elements (e.g., ND filters) with a plurality of different attenuation ratios. The light having passed through the optical member 122 reaches an optical unit 102. The optical unit 102 reduces an illuminance variation by oscillating the angle of coherent light. The light having passed through the optical unit 102 enters a beam shaping optical system 103. The beam shaping optical system 103 shapes the sectional shape of light and converts it into incoherent light.

The light having passed through the beam shaping optical system 103 enters a condenser lens 106 upon passing through an optical integrator 105. The condenser lens 106 illuminates a masking blade 109 with the light from a secondary light source formed by the optical integrator 105. The light having passed through the condenser lens 106 is partially extracted by a half mirror 107 and guided to a photodetector 112 via a condenser lens 111. The photodetector 112 is used to monitor the exposure dose on a substrate (wafer) 118 during its exposure.

The masking blade 109 includes, for example, four upper, lower, left, and right light-shielding plates which are driven independently. The masking blade 109 is located on a plane optically conjugate to an original (reticle) 116 with respect to an imaging lens 110. A slit member 108 includes, for example, a pair of light-shielding plates. The slit member 108 is set at a position shifted in the optical-axis direction from the plane on which the masking blade 109 is located. With this arrangement, the light having passed through the slit member 108 forms a light intensity distribution having a trapezoidal sectional shape. The imaging lens 110 illuminates the original 116 with the light having passed through the slit member 108 and masking blade 109.

A projection optical system 113 projects the pattern of the original 116 onto the substrate 118.

An original stage 115 holds the original 116, and a substrate stage 117 holds the substrate 118. The original stage 115 and substrate stage 117 are driven while levitating by, for example, air pads.

The photodetector 112 detects and controls the exposure dose on the substrate 118. The substrate stage 117 mounts an illuminometer 114. The photodetector 112 can monitor the exposure dose on the substrate 118 by examining the relationship between the detection results obtained by the illuminometer 114 and photodetector 112.

For various types of calibration such as position adjustment between the original stage 115 and the substrate stage 117, a fiducial mark 126 is located on the substrate stage 117.

This scanning exposure apparatus includes two substrate stages 117 and 119. The positions of the two substrate stages 117 and 119 can be swapped for each other. A stage controller 128, for example, controls the substrate stages 117 and 119. The substrate stage 119 has basically the same arrangement as that of the substrate stage 117. The substrate stage 119 includes, for example, an illuminometer 120 and fiducial mark 127.

A scope 132 used for focus measurement and alignment measurement is located in a measurement station for focus measurement (substrate surface position measurement) and alignment measurement. The scope 132 is also used to measure the amount of strain and the three-dimensional shape of a substrate 121. While the substrate held by the substrate stage 117 is exposed under the projection optical system 113, the one held by the substrate stage 119 is measured under the scope 132. A twin-stage type scanning exposure apparatus achieves a high throughput by measuring the next substrate while one substrate is exposed.

A measurement controller 129 controls focus measurement and alignment measurement. A main controller 130 (corresponding to a controller defined in “WHAT IS CLAIMED IS”) controls the stage controller 128 and measurement controller 129.

The stage controller 128 and measurement controller 129 are directly connected to each other such that an interrupt request can be issued for the processing in the measurement controller 129 in accordance with the position of the substrate stage 119.

In response to the issued interrupt request, focus measurement is performed. Alternatively, focus measurement may be performed at the timing, when the substrate stage 119 reaches a target position, which is detected by referring to, by the measurement controller 129, the current position of the substrate stage 119 controlled by the stage controller 128. A time delay attributed to intervention of the main controller 130 can be minimized by directly connecting the stage controller 128 and measurement controller 129 to each other.

An interface 124 includes an input device (e.g., a keyboard and a mouse), and specifies the operation of the scanning exposure apparatus in accordance with an instruction issued from the input device. Also, the interface 124 manages conditions such as the substrate exposure conditions and the shot layout. The operator operates the scanning exposure apparatus under the conditions selected from the managed conditions. The interface 124 is also connected to, for example, a backbone network (e.g., a local network) 125 operated under the environment under which the scanning exposure apparatus is installed. This enables the interface 124 to download the operation conditions of the scanning exposure apparatus and the like from the backbone network 125.

The main controller 130 controls each unit of the scanning exposure apparatus in accordance with an instruction issued from the operator or the network 125 via the interface 124.

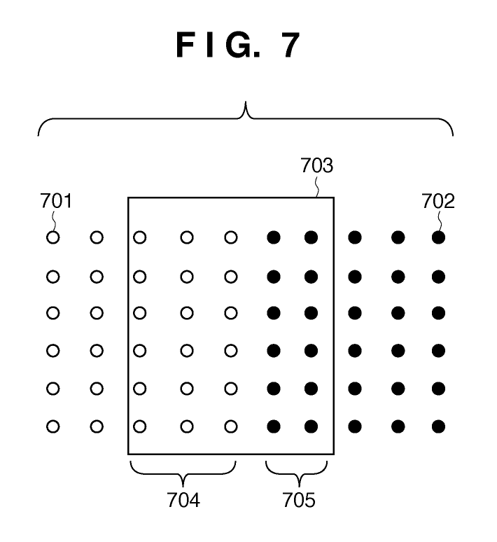

The items of measurement in the measurement station include, for example, measurement (alignment measurement) of the amount of strain of a substrate in a portion having a shot layout drawn, and measurement (focus measurement) of the substrate surface position (or surface shape). For this reason, the array of measurement target points is not limited by that of shot regions, unlike a system which simultaneously performs measurement and exposure. For example, as illustrated in FIG. 7, prior to exposure in a shot region 703, the driving amount of the substrate stage for focus control in the shot region 703 may be determined based on measurement results 701 and 702 obtained by scanning operations at different times. In this example, information belonging to a region 704 in the result 701, and that belonging to a region 705 in the result 702 can be used.

A twin-stage system has a feature that it allows focus measurement without arranging measurement points on a focus sensor in the non-scanning direction, and this feature can be exploited in this embodiment.

In the embodiment of the present invention, the substrate surface position or surface shape is measured at a distance smaller than that at which measurement points are arranged on a focus sensor (measurement device) 131. This measurement is implemented by determining the arrangement direction in which a plurality of measurement points are aligned and the scanning direction of a shot region such that the arrangement direction and the scanning direction are not orthogonal to each other. The arrangement direction and the scanning direction do not match, as a matter of course.

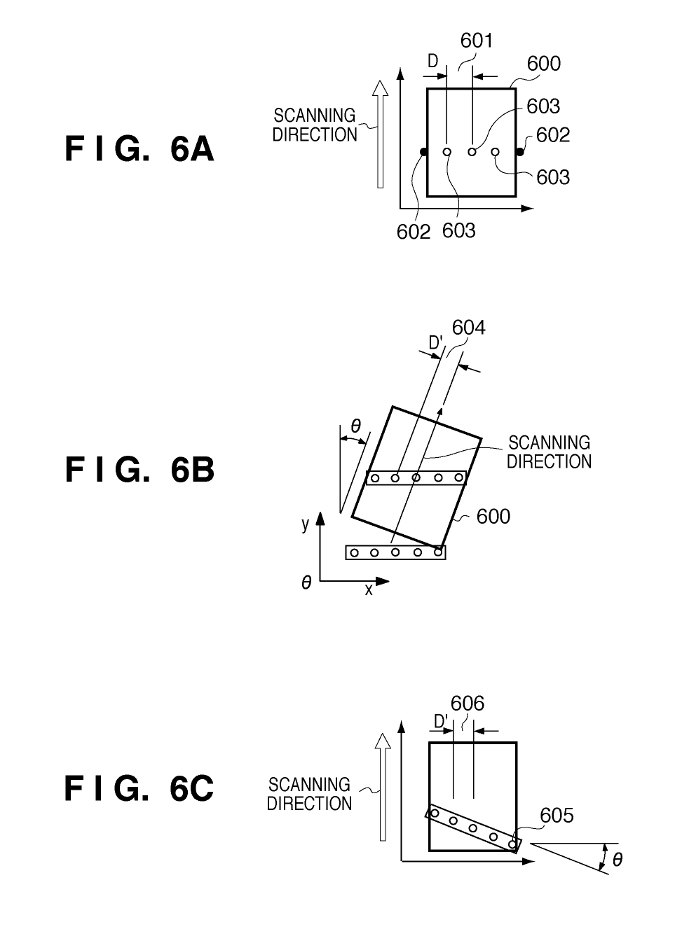

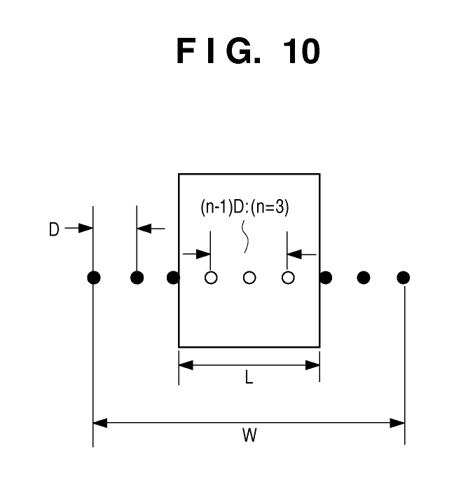

As shown in FIG. 6A, when the measurement points 602 are positioned outside the shot region 600, the conventional method cannot be used to measure a region inside the shot region 600 at the measurement points 602. Let L be the width of the shot region 600; D be the distance 601 between measurement target points 603, in the non-scanning direction (a direction perpendicular to the scanning direction), in the shot region 600 having a pattern; W be the width of a measurable region, that is a distance between two outermost measurement points; and n be an integer. Then, the number of measurement points used is the maximum value of an integer n which satisfies W>(n−1)D. In FIG. 10, measurement points indicated by open circles are used, whereas those indicated by closed circles are not used. In this embodiment, the distance between measurement target points in the non-scanning direction is reduced by determining the arrangement direction of a plurality of measurement points and the scanning direction of a shot region such that the arrangement direction and the scanning direction are not orthogonal to each other. That is, the distance between measurement target points in the non-scanning direction can be reduced by measuring the substrate surface position by a focus sensor under the condition that the arrangement direction of a plurality of measurement points and the scanning direction of a shot region are not orthogonal to each other.

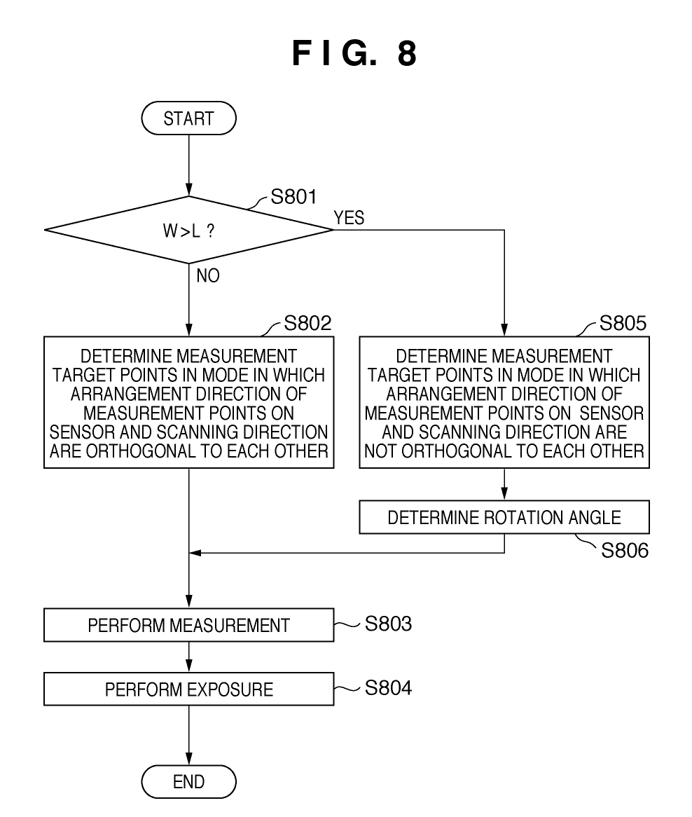

FIG. 8 is a flowchart schematically showing the sequence of substrate processing in the first embodiment of the present invention. Note that in this embodiment, the main controller (controller) 130 controls the processing shown in this flowchart.

In step S801, the main controller 130 compares the width W of the measurable region and the width L of the shot region. If W≦L, the main controller 130 advances the process to step S802. If W>L, the main controller 130 advances the process to step S805. To measure the substrate surface position in a region having a width (L-α) narrower than the width L of the shot region, (L-α) is to be substituted for L. Note that α is a positive integer.

In step S802, measurement target points in a non-rotation mode are determined, as in the conventional techniques. In the non-rotation mode, the arrangement direction of a plurality of measurement points on the focus sensor 131, and the substrate scanning direction are orthogonal to each other. Note that the measurement target point means a point, on the substrate, at which the substrate surface position is measured.

In step S805, the main controller 130 determines measurement target points in a rotation mode. In the rotation mode, the arrangement direction of a plurality of measurement points on the focus sensor 131, and the substrate scanning direction are not orthogonal to each other. The rotation mode is implemented by rotating a substrate and setting the substrate scanning direction to be parallel to the side of a shot region on the substrate (first method), or by rotating the arrangement direction of a plurality of measurement points on the focus sensor 131 (second method). In general, the latter method (second method) does not have rotating the substrate and the scanning direction but has rotating the focus sensor 131 by a rotating mechanism 190, so the former method (first method) is easier.

In step S806, if the rotation mode is the first method, the main controller 130 determines a rotation angle θ of the substrate with respect to a reference direction (e.g., the y direction) (and of the scanning direction with respect to a reference direction (e.g., the y direction). Alternatively, in step S806, if the rotation mode is the second method, the main controller 130 determines a rotation angle θ of the arrangement direction of a plurality of measurement points on the focus sensor 131 with respect to a reference direction (e.g., the x direction). The rotation angle θ can be calculated, for example, in accordance with:

θ=cos⁻¹(L/W) (1)

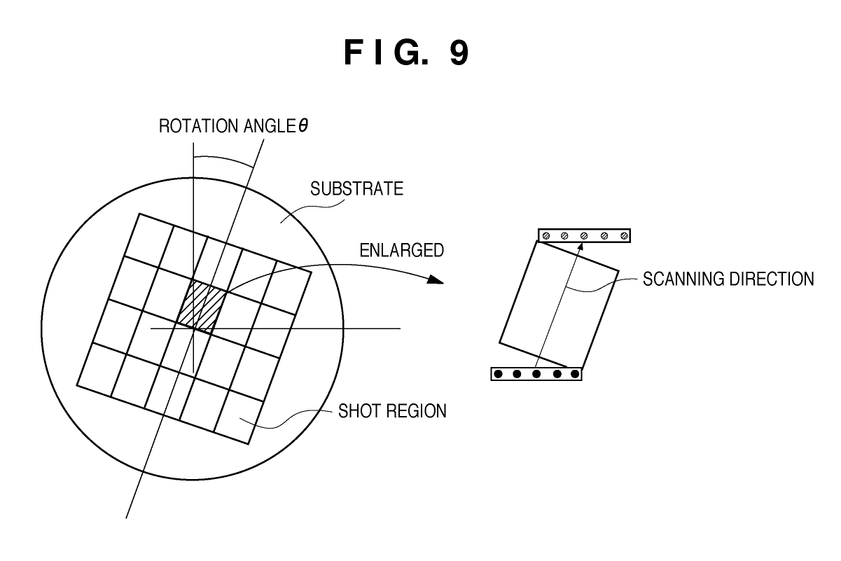

FIGS. 6B and 9 illustrate rotation according to the first method. FIG. 6C illustrates rotation according to the second method. To measure the substrate surface position in a region having a width (L-α) narrower than the width L of the shot region, (L-α) is to be substituted for L.

In the non-rotation mode, the main controller 130 controls the stage controller 128 and measurement controller 129 so as to measure the substrate surface positions at the measurement target points determined in step S1102, in the measurement station in step S803. In the rotation mode, the main controller 130 controls the stage controller 128 and measurement controller 129 so as to measure the substrate surface positions in accordance with the measurement target points and the rotation angle θ determined in steps S805 and S806, in the measurement station in step S803. When the substrate is rotated through the rotation angle θ for measurement (i.e., in the first mode), the main controller 130 controls the stage controller 128 so as to rotate the substrate through −θ after the end of measurement. The substrates on the substrate stages 117 and 119 may be rotated by rotating the substrate stages 117 and 119, by rotating the substrate chucks mounted on the substrate stages 117 and 119, or by another method.

In step S804, the main controller 130 controls the stage controller 128 and associated constituent elements of the exposure station so as to expose the measured substrate in the exposure station based on the measurement result obtained in step S803. Note that the substrate stages 117 and 119 are swapped between steps S803 and S804.

Reference symbol D′ in FIG. 6B denotes the distance 604 (or 606 as shown in FIG. 6C) between measurement target points in a direction perpendicular to the scanning direction when the substrate and the substrate scanning direction are rotated (the same applies to a case in which the arrangement direction of a plurality of measurement points on the focus sensor 131 is rotated as shown in FIG. 6C). In the non-rotation mode, the distance between measurement target points is D that is equal to that between measurement points on the focus sensor 131. In contrast, in the rotation mode, the distance between measurement target points is D′ (=Dcosθ). Hence, the substrate surface position (surface shape) can be measured at a smaller measurement pitch in the rotation mode than in the non-rotation mode. It is noted that element 605 is denoted as the measurement target point according to one embodiment shown in FIG. 6C.

In this embodiment, the non-rotation mode or the rotation mode is selected based on whether all measurement points on the focus sensor 131 fall within the width of a shot region. Instead, the non-rotation mode or the rotation mode may be selected based on the measurement pitch. In other words, the rotation mode is to be selected only if the substrate surface position is to be measured at a smaller measurement pitch than in the non-rotation mode.

In a second embodiment, a rotation angle θ corresponding to the measurement pitch is determined. Note that details which are not particularly referred to in the second embodiment can be the same as in the first embodiment.

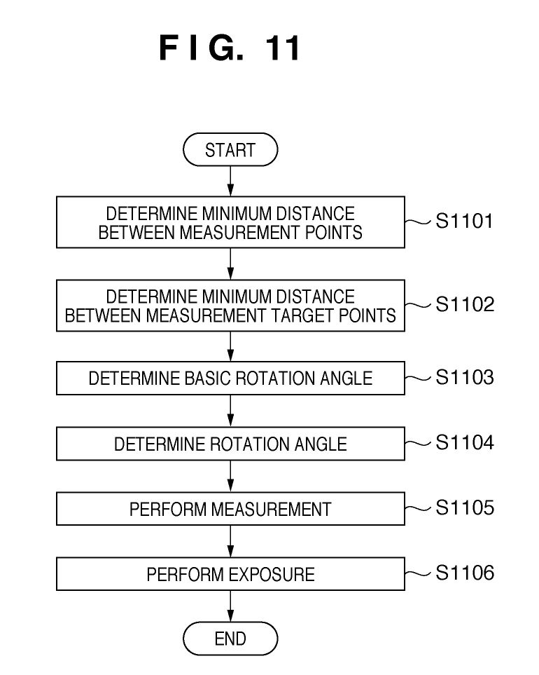

FIG. 11 is a flowchart schematically showing the sequence of substrate processing in the second embodiment of the present invention. Note that in this embodiment, a main controller 130 controls the processing shown in this flowchart.

In step S1101, the main controller 130 determines, as a minimum distance Δd between measurement points, the smaller one of a distance D between a plurality of measurement points on a focus sensor 131 and a distance SP between measurement points in the substrate scanning direction as a default. The distance between measurement points in the substrate scanning direction as a default is the sampling interval (=sampling time interval×scanning velocity). The minimum distance Δd may also be set in a scanning exposure apparatus in advance.

In step S1102, the main controller 130 reads distances S1 and S2 between measurement target points in directions parallel to the long and short sides, respectively, of the shot region designated via, for example, an interface 124. The main controller 130 then determines the smaller one of the read distances S1 and S2 between measurement target points as a minimum distance Id between measurement target points (i.e., determine minimum distance between measurement target points).

In step S1103, the main controller 130 determines a basic rotation angle (basic direction) θ0 of the substrate as 0° or 90° such that the direction in which the distance Δd between measurement points is minimum (this is the direction in which the measurement points are aligned) matches that in which the distance Δd between measurement target points is minimum (this is the direction in which the measurement target points are aligned).

In step S1104, the main controller 130 determines a rotation angle θ in accordance with:

θ=θ0+cos⁻¹(L/W) (2)

If the rotation mode is the first method, the rotation angle θ means the rotation angle of the substrate with respect to a reference direction (e.g., the y direction) (and of the scanning direction with respect to a reference direction (e.g., the y direction)). Alternatively, if the rotation mode is the second method, the rotation angle θ means the rotation angle of the arrangement direction of a plurality of measurement points on the focus sensor 131 with respect to a reference direction (e.g., the x direction).

In step S1105 (i.e., perform measurement), the main controller 130 controls a stage controller 128 and measurement controller 129 so as to measure the substrate surface position in accordance with the rotation angle θ, determined in step S1104, in the measurement station. When the substrate is rotated through the rotation angle θ for measurement (i.e., in the first mode), the main controller 130 controls the stage controller 128 so as to rotate the substrate through −θ after the end of measurement.

In step S1106 (i.e., perform exposure), the main controller 130 controls the stage controller 128 and associated constituent elements of the exposure station so as to expose the measured substrate in the exposure station based on the measurement result obtained in step S1105. Note that substrate stages 117 and 119 are swapped between steps S1105 and S1106.

In a third embodiment, the surface position of a substrate is measured by rotating the substrate such that the direction in which the cycle of a change in sectional shape of the substrate surface is minimum (the direction in which a change in sectional shape is minutest) matches the scanning direction. That is, in the third embodiment, the surface positions are measured under a condition that the arrangement direction and a scanning direction of the substrate are orthogonal to each other, and the scanning direction and a direction parallel to a side of a shot region on the substrate are not orthogonal to each other.

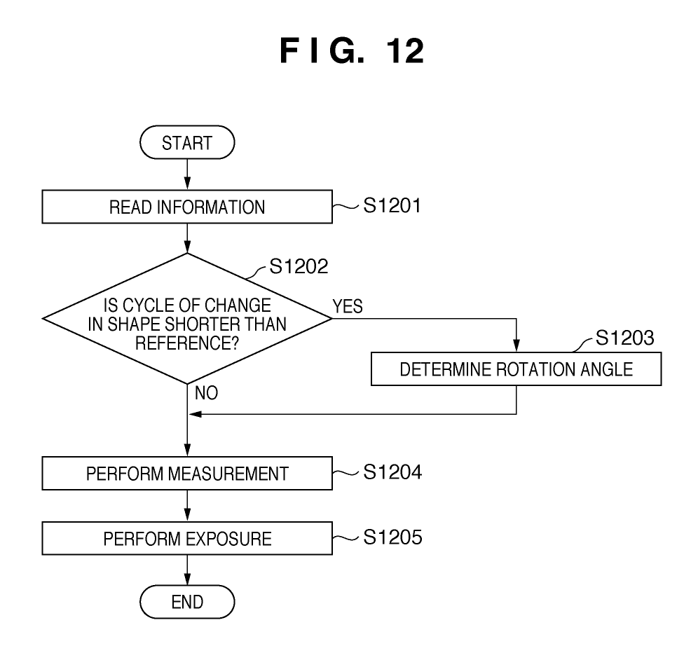

FIG. 12 is a flowchart schematically showing the sequence of substrate processing in the third embodiment of the present invention. Note that in this embodiment, a main controller 130 controls the processing shown in this flowchart.

In step S1201, the main controller 130 acquires (i.e., read) information concerning the surface shape of a substrate as an exposure target (measurement target). The information can include, for example, information concerning the pattern formed on the substrate, and the topography of the substrate. Information concerning the pattern formed on the substrate can be acquired from, for example, a recipe file.

In step S1202, the main controller 130 determines whether the cycle of a change in substrate surface shape is shorter than a predetermined reference (e.g., whether this cycle is shorter than the distance between measurement points on a focus sensor 131). If NO in step S1202, the main controller 130 advances the process to step S1204. If YES in step S1202, the main controller 130 advances the process to step S1203.

In step S1203, the substrate rotation angle is determined such that the direction in which the cycle of a change in substrate surface shape is minimum matches the substrate scanning direction. The substrate rotation angle may be an angle (designated angle) designated by the user. In this case, the main controller 130 can determine in step S1202 whether the user has designated the substrate rotation angle, and advance the process to step S1203 if YES in step S1202. The distance between measurement points in the substrate scanning direction is determined depending on the sampling interval of the focus sensor 131 and the scanning velocity. From this viewpoint, it is easy to reduce the distance between measurement points. Hence, the substrate surface shape can be measured at a smaller distance by matching the direction in which the cycle of a change in substrate surface shape is minimum with the substrate scanning direction.

If step S1203 is executed, in step S1204 the main controller 130 controls a stage controller 128 and measurement controller 129 so as to measure the substrate in the rotation mode. More specifically, if step S1203 is executed, in step S1204 (i.e., perform measurement) the main controller 130 controls the stage controller 128 and measurement controller 129 so as to measure the substrate surface position in accordance with a rotation angle θ, determined in step S1203, in the measurement station. When the substrate is rotated through the rotation angle θ for measurement (i.e., in the first mode), the main controller 130 controls the stage controller 128 so as to rotate the substrate through −θ after the end of measurement.

If step S1203 is not executed (“NO” in step S1202), the main controller 130 controls the stage controller 128 and measurement controller 129 so as to measure the substrate in the non-rotation mode. More specifically, if step S1203 is not executed, the main controller 130 controls the stage controller 128 and measurement controller 129 so as to measure the substrate without rotating the substrate.

In step S1205 (i.e., perform exposure), the main controller 130 controls the stage controller 128 and associated constituent elements of the exposure station so as to expose the measured substrate in the exposure station based on the measurement result obtained in step S1204. Note that substrate stages 117 and 119 are swapped between steps S1204 and S1205.

A device manufacturing method according to an embodiment of the present invention can be used to manufacture devices such as a semiconductor device and a liquid crystal device. This method can include, for example, a step of exposing a substrate coated with a photosensitive agent using a scanning exposure apparatus, and a step of developing the exposed substrate. The device manufacturing method can also include known subsequent steps (e.g., oxidation, film formation, vapor deposition, doping, planarization, etching, resist removal, dicing, bonding, and packaging).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-275920, filed Oct. 27, 2008, which is hereby incorporated by reference herein in its entirety.

What is claimed is:

1. An apparatus comprising: a device which measures a surface position of a substrate at a plurality of measurement points; and
a controller configured to cause the device to measure the surface position under a condition that an arrangement direction in which the plurality of measurement points are arranged and a scanning direction of the substrate are not orthogonal to each other,
wherein exposure on the substrate is controlled based on a measurement result obtained by the device.

2. The apparatus according to claim 1, wherein
the controller is further configured to determine a rotation angle of the substrate with respect to a reference direction such that a direction parallel to a side of a shot region and the arrangement direction are not orthogonal to each other, and to determine the direction parallel to the side of the shot region on the substrate as the scanning direction.

3. The apparatus according to claim 2, wherein the substrate is measured in accordance with the determined rotation angle and the scanning direction.

4. The apparatus according to claim 1, further comprising
a mechanism configured to rotate the device,
wherein the controller is further configured to determine a rotation angle of the arrangement direction with respect to a reference direction such that a direction parallel to a side of a shot region on the substrate is not perpendicular to the arrangement direction.

5. The apparatus according to claim 4, wherein the mechanism is further configured to rotate the device in accordance with the determined rotation angle.

6. The apparatus according to claim 1, wherein the controller is further configured to determine an angle between the arrangement direction and the scanning direction such that the arrangement direction and the scanning direction are not orthogonal to each other when a distance between two outermost measurement points of the plurality of measurement points, is wider than a width of a shot region on the substrate.

7. The apparatus according to claim 1, wherein the controller is further configured to determine an angle between the arrangement direction and the scanning direction such that a distance between measurement points on the substrate in a direction perpendicular to the scanning direction is equal to a distance between measurement target points on the substrate.

8. The apparatus according to claim 1, further comprising
two stages configured to hold substrates,
a measurement station in which the device is located, and
an exposure station,
wherein the two stages are controlled such that a substrate is exposed in the exposure station after being measured by the measurement device in the measurement station.

9. An apparatus comprising: a device which measures a surface position of a substrate at a plurality of measurement points; and
a controller configured to cause the device to measure the surface position under a condition that an arrangement direction in which the plurality of measurement points are aligned and a scanning direction of the substrate are orthogonal to each other, and the scanning direction and a direction parallel to a side of a shot region on the substrate are not orthogonal to each other,
wherein exposure on the substrate is controlled based on a measurement result obtained by the device.

10. The apparatus according to claim 9, wherein
the controller is further configured to determine a rotation angle of the substrate such that the scanning direction and the direction parallel to the side of the shot region form a designated angle.

11. The apparatus according to claim 10, wherein the substrate is measured in accordance with the determined rotation angle.

12. A method comprising:
exposing a substrate by an apparatus; and
developing the substrate,
wherein the apparatus comprises:
a device which measures a surface position of a substrate at a plurality of measurement points; and
a controller configured to cause the device to measure the surface position under a condition that an arrangement direction in which the plurality of measurement points are arranged and a scanning direction of the substrate are not orthogonal to each other,
wherein exposure on the substrate is controlled based on a measurement result obtained by the device.

13. A method comprising:
exposing a substrate by an apparatus; and
developing the substrate,
wherein the apparatus comprises:
a device which measures a surface position of a substrate at a plurality of measurement points;
a controller configured to cause the measurement device to measure the surface position under a condition that an arrangement direction in which the plurality of measurement points are aligned and a scanning direction of the substrate are orthogonal to each other, and the scanning direction and a direction parallel to a side of a shot region on the substrate are not orthogonal to each other,
wherein exposure on the substrate is controlled based on a measurement result obtained by the device.

14. The method according to claim 12, wherein
the controller is further configured to determine a rotation angle of the substrate with respect to a reference direction such that a direction parallel to a side of a shot region and the arrangement direction are not orthogonal to each other, and to determine the direction parallel to the side of the shot region on the substrate as the scanning direction.

15. The method according to claim 14, wherein the substrate is measured in accordance with the determined rotation angle and scanning direction.

16. The method according to claim 12, further comprising
a mechanism configured to rotate the device,
wherein the controller is further configured to determine a rotation angle of the arrangement direction with respect to a reference direction such that a direction parallel to a side of a shot region on the substrate is not perpendicular to the arrangement direction.

17. The method according to claim 16, wherein the mechanism is further configured to rotate the device in accordance with the determined rotation angle.

18. The method according to claim 12, wherein the controller is further configured to determine an angle between the arrangement direction and the scanning direction such that the arrangement direction and the scanning direction are not orthogonal to each other when a distance between two outermost measurement points of the plurality of measurement points, is wider than a width of a shot region on the substrate.

19. The method according to claim 12, wherein the controller is further configured to determine an angle between the arrangement direction and the scanning direction such that a distance between measurement points on the substrate in a direction perpendicular to the scanning direction is equal to a distance between measurement target points on the substrate.

20. The method according to claim 13, wherein
the controller is further configured to determine a rotation angle of the substrate such that the scanning direction and the direction parallel to the side of the shot region form a designated angle and the substrate is measured in accordance with the determined rotation angle.
